(19) United States
(12) Patent Application Publication
(10) Pub. No.: US 2011/0111178 A1
(43) Pub. Date: May 12, 2011

(54) STRUCTURES HAVING AN ADJUSTED MECHANICAL PROPERTY

(75) Inventors: Samuel Jonas Wind, White Plains, NY (US); Michael P. Sheetz, New York, NY (US); Teresa Anne Fazio, Poughkeepsie, NY (US)

(73) Assignee: The Trustees of Columbia University in theCity of, New York, NY (US)

(21) Appl. No.: 12/936,025

(22) PCT Filed: Apr. 2, 2009
(86) PCT No.: PCT/US2009/002069

§ 371 Date: Dec. 21, 2010

Related U.S. Application Data
(60) Provisional application No. 61/072,717, filed on Apr. 2, 2008.

(51) Int. Cl. B32B 3/30; G21G 5/00

(52) U.S. Cl. 428/170; 250/492.3

(57) ABSTRACT

In various embodiments, the properties of a cross-linkable polymer can be changed by modifying the degree of cross-linking. The degree of cross-linking can be modified on a localized basis using lithographic patterns in which the cross-linkable polymer can be selectively and controllably subjected to charged particles or electromagnetic radiation. The modification of the degree of cross-linking can be applied to substrates having surfaces with varying geometric forms.

### CROSS-REFERENCE TO RELATED APPLICATIONS

This application claims priority to U.S. Provisional Application Ser. No. 61/072,717 filed 2 Apr. 2008, entitled “SYSTEMS AND METHODS FOR VARIABLE RIGIDITY SURFACES,” which application is incorporated herein by reference.

All patents, patent applications, and publications cited herein are hereby incorporated by reference in their entirety.

### STATEMENT REGARDING FEDERALLY SPONSORED RESEARCH OR DEVELOPMENT

This invention was made with government support under award number PN2 EY 016586 awarded by the NIH Roadmap for Medical Research from the National Institutes of Health. This invention was also made with government support under NSF Award Number CHE-0641523 awarded by the Nanoscale Science and Engineering Initiative of the National Science Foundation. The government has certain rights in this invention.

This invention was also made with government support from the New York State Office of Science, Technology, and Academic Research (NYSTAR). The government has certain rights in this invention.

### BACKGROUND

Polydimethylsiloxane (“PDMS”)) base material can be cured with deep ultraviolet (DUV) radiation, which in certain examples can obtain a DUV PDMS resolution of about 10 micrometers. See, e.g., K. Tsougeni et al., Microelectronic Engineering 84 (2007) 1104-1008. As seen from FIGS. 1-3, a photoinitiator may be required for such DUV radiation curing. FIG. 1 shows optical absorption of 1.2 μm thick PDMS (PS 264 copolymer) without and with 4% photoinitiator, where α=0.026 μm⁻¹ at 248 nm and α=0.38 μm⁻¹ at 365 nm, respectively. FIG. 2 shows contrast curves of PDMS in DUV with and without photoinitiator. Curve 201 is for PS 264 for 1.2 μm thickness without photoinitiator, curve 202 is for VDT 954 for 8 μm thickness with a photoinitiator, and curve 203 is for a Sylgard 184-base for 0.18 μm thickness with the photoinitiator. FIG. 3 shows contrast curves of PDMS at UV (300-400 nm radiation) with a photoinitiator. Curve 301 is for VDT 954 for 1.2 μm thickness with a photoinitiator and curve 302 is for VDT 954 for 8 μm thickness with another photoinitiator. For UV exposures at 300-400 nm, a glass slide was used to filter out radiation below 300 nm, and to make sure that cross-linking was due to 300-400 nm. Sensitivity values shown on the figure are determined at 99% of final attained thickness.

### SUMMARY

In various embodiments, the properties of a cross-linkable polymer can be changed by modifying the degree of cross-linking. The degree of cross-linking can be modified on a localized basis using lithographic patterns in which the cross-linkable polymer can be selectively and controllably subjected to charged particles or electromagnetic radiation. The modification of the degree of cross-linking can be applied to substrates having surfaces with varying geometric forms. In various embodiments, an elastomer on a substrate is modified to have regions of locally varying rigidity.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

Embodiments are illustrated by way of example and not limitation in the figures of the accompanying drawings.

FIG. 1 shows optical absorption of 1.2 μm thick PDMS without and with 4% photoinitiator.

FIG. 2 shows contrast curves of PDMS in DUV with and without photoinitiator.

FIG. 3 shows contrast curves of PDMS at UV (300-400 nm radiation) with a photoinitiator.

FIG. 4 shows an example of a PDMS starting material that can be molded with upward-rising microscale pillars to provide a biocompatible environment for studying a neural progenitor or other living cells, according to various embodiments.

FIG. 5 shows a PDMS base selectively cured by e-beam exposure at 30 keV, according to various embodiments.

FIG. 6 shows a 10× picture of results of a PDMS base selectively cured by e-beam exposure for a dose of 80 μC/cm², according to various embodiments.

FIG. 7 shows a 50× picture of results of forming square posts of a PDMS base selectively cured by e-beam exposure, according to various embodiments.

FIGS. 8A-B and 9A-F illustrate blistering and delamination of a cured PDMS exposed to an electron beam without providing a conducting discharge layer, according to various embodiments.

FIG. 10 shows an example of a 20 micrometer thick layer of cured PDMS on a silicon substrate before electron beam exposure, and without any conducting discharge layer, according to various embodiments.

FIGS. 11A-11F show an example of AFM results of cured PDMS on a silicon substrate with a discharge layer provided then exposed to an electron beam, according to various embodiments.

FIG. 12 shows a pre-molded pillared PDMS surface selectively exposed to EBL with no electron beam exposure, according to various embodiments.

FIG. 13 shows a pillared PDMS material after selective exposure to an electron beam dose of about 150 microCoulombs per square centimeter, according to various embodiments.

FIG. 14 shows a comparison between exposed and unexposed regions of a pillared PDMS material, according to various embodiments.

FIGS. 15 and 16 compare the dimensions of an example of exposed and unexposed pillars of PDMS material, according to various embodiments.

FIG. 17 shows that rigidity increases with increasing electron beam dose, according to various embodiments.

FIG. 18 shows an example of results in which a pillared PDMS substrate was sputter-coated with AuPd before electron-beam exposure, according to various embodiments.

FIG. 19 shows a cell on a substrate having pillars for testing cell response, according to various embodiments.

FIG. 20 shows a surface with patterned areas of gradients of pillars having varying rigidity, according to various embodiments.

FIG. 21 shows a surface with rigidity selected to have a rigidity gradient changing in an arbitrarily selected pattern from a selected position, according to various embodiments.

FIG. 22 shows a region of a surface in which the rigidity of the surface varies from a flexible area to a rigid area, according to various embodiments.

FIG. 23 illustrates varying rigidity among pillars, according to various embodiments.

FIG. 24 shows a Monte Carlo simulation of energy distribution from a PDMS surface subjected to 30 kV generated electrons, according to various embodiments.

FIG. 25 shows a Monte Carlo simulation of energy distribution from a PDMS surface subjected to 100 kV generated electrons, according to various embodiments.

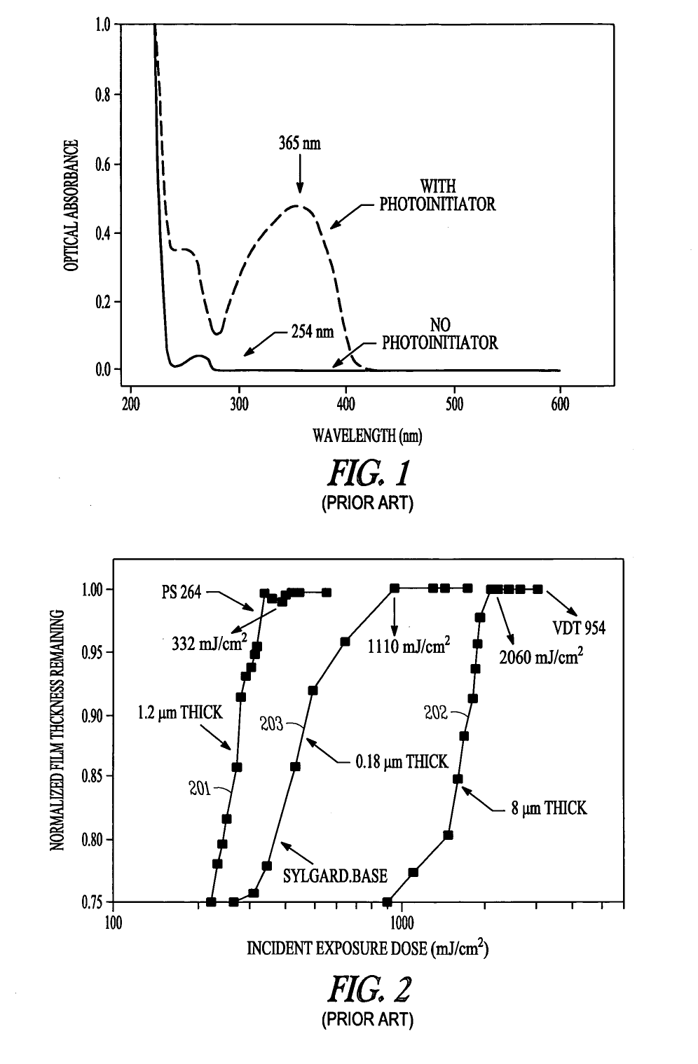

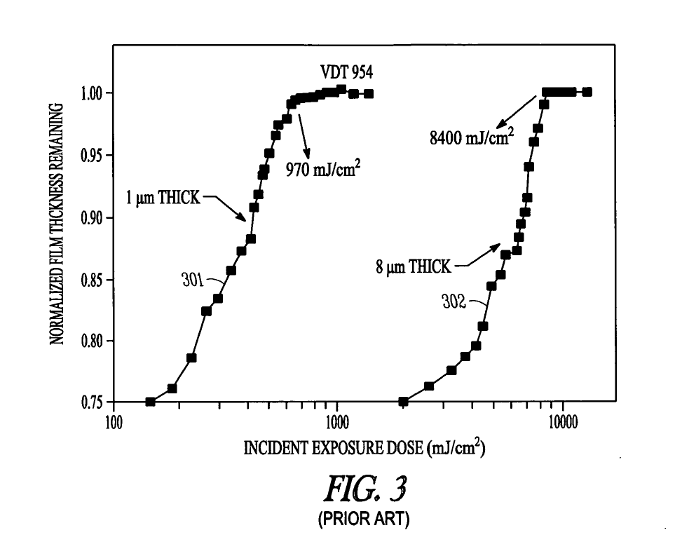

### DETAILED DESCRIPTION

In various embodiments, the properties of a cross-linkable polymer can be changed by modifying the degree of cross-linking. The degree of cross-linking can be modified on a localized basis using lithographic patterns in which the cross-linkable polymer can be selectively and controllably subjected to charged particles or electromagnetic radiation. For example, the properties of elastomeric materials, which are cross-linkable polymers, can be changed by modifying the degree of cross-linking of the elastomeric material. The modification of the degree of cross-linking can be applied to substrates having surfaces with varying geometric forms. Such geometric forms on the surfaces can include, but are not limited to, pillars, grooves, ridges, and other forms.

The present inventors have recognized, among other things, that mechanical rigidity of a living or non-living artificial environment can impact motility, adhesion, differentiation, or other behavior or function of living cells. For example, environmental rigidity can play a role in cancerous cell growth. In another example, environmental rigidity can play a role in stem cell differentiation. The present inventors have also recognized that EBL makes it possible to modify the rigidity of structures at the nanoscale, including locally modifying rigidity of a structure at the nanoscale.

In various embodiments, an elastomer is subjected to controlled dosages of charged particles or electromagnetic radiation to selectively adjust a rigidity at localized portions of the elastomer. The elastomer can be disposed on a substrate with a pattern selected based on a criteria for the pattern according to the application in which it is to be implemented. The charged particles can include electrons or ions. The electromagnetic radiation can include UV radiation, DUV radiation, radiation in the visible spectrum, or other range of electromagnetic energy depending on the application for the elastomeric material. The electromagnetic radiation may be used with a photoinitiator for the elastomeric material. The photoinitiator can be in a form that absorbs electromagnetic radiation in applications in which the elastomeric material is transparent to the electromagnetic radiation. The added material absorbs the light such that cross-linking in the elastomeric material is initiated.

In various embodiments, a structure comprises a substrate and a cross-linkable polymeric material disposed on the substrate, where the cross-linkable polymeric material has a surface of locally varying rigidity corresponding to a selected geometric form on the substrate. The cross-linkable polymeric material can include an elastomeric material. The elastomeric material can include a biocompatible polymeric material, such as PDMS. The rigidity of the cross-linkable polymeric material can be selected, but is not limited to, having rigidity values between about 200 Pa and about 1 GPa.

In an illustrative example, an at least partially cured biocompatible polymeric starting material (e.g., silicone rubber or PDMS) is provided. The starting material is selectively exposed to energy, such as an electron-beam provided during electron beam lithography (EBL). This performs selective curing that increases the cross-linking in specified regions, thereby solidifying or otherwise locally increasing the rigidity of such selectively exposed regions relative to other regions that are not so exposed. The selective exposure can be used to generate a specified pattern or structure providing a variable rigidity microenvironment, such as for living cells, a microfluidic application, or the like. A biocompatible material, such as PDMS, that is cross-linkable can be used to create an environment for living cells. An electron discharge layer can be provided before the EBL is carried out.

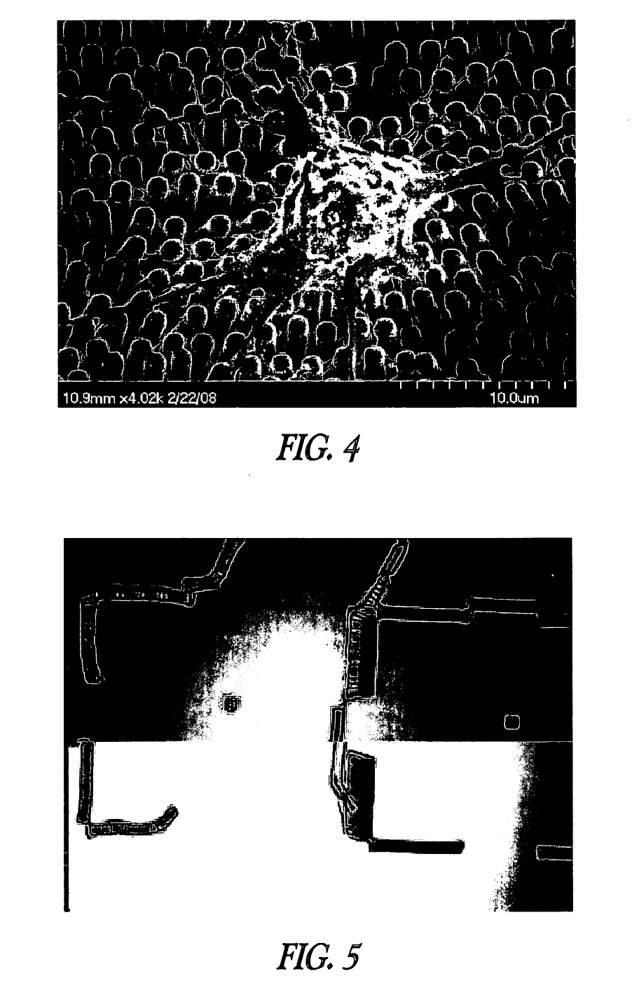

FIG. 4 shows an example of a PDMS starting material that can be molded with upward-rising microscale pillars (e.g., about 10 micrometers in diameter) to provide a biocompatible microenvironment for studying a neural progenitor or other living cells. A cell can attach to such pillars during cell growth, imparting nano-Newton forces. The force imparted by the cell upon the pillar can be inferred from the amount of deflection observed in the pillar.

The present inventors have recognized, among other things, that EBL can be used to selectively and controllably expose the pillars to a current of accelerated electrons. This can change the cross-linking of the polymer in the pillar by a desired degree, thereby increasing its rigidity by a desired degree. By locally altering the electron exposure dosage, regions of different rigidities can be created on the same starting material. Individual pillars can have their rigidity individually adjusted, as desired. Thus, this technique can be used to obtain variable-rigidity surfaces, sub-micron scale rigidity variation, or to determine the interaction between a living cell and an extracellular matrix (ECM).

In various embodiments, a biocompatible polymeric structure, such as PDMS with a patterned surface, has locally varying rigidity corresponding to rigidity values selected to affect a characteristic of a living cell and has a spatial dimension, associated with the rigidity values, that is also selected to affect the characteristic of the living cell. The rigidity values and the dimension of the localized spatial region can be selected to affect cancerous cell growth. The rigidity values and the dimension of the localized spatial region can be selected to affect stem cell differentiation. The biocompatible structure can have varying structural forms with rigidity values that can be selected to be between about 10 kPa and about 1 MPa.

Illustrative examples of an EBL selective rigidity enhancement of PDMS are described below. In an illustrative example, a 20 micrometer thick layer of PDMS can be spun-on or otherwise formed onto a silicon substrate, and then pre-baked for approximately 1 minute at a temperature of approximately 50 degrees Celsius. Supportive substrates are not limited to silicon substrates. EBL can then be performed, such as at an exposure dose of between about 30 μC/cm² and about 80 μC/cm². This can be followed by a post-bake for approximately 5 minutes at about 120 degrees Celsius. The PDMS substrate can then be developed, such as by using IPA:MIBK 1:1 for an approximately 3 minute developing time period.

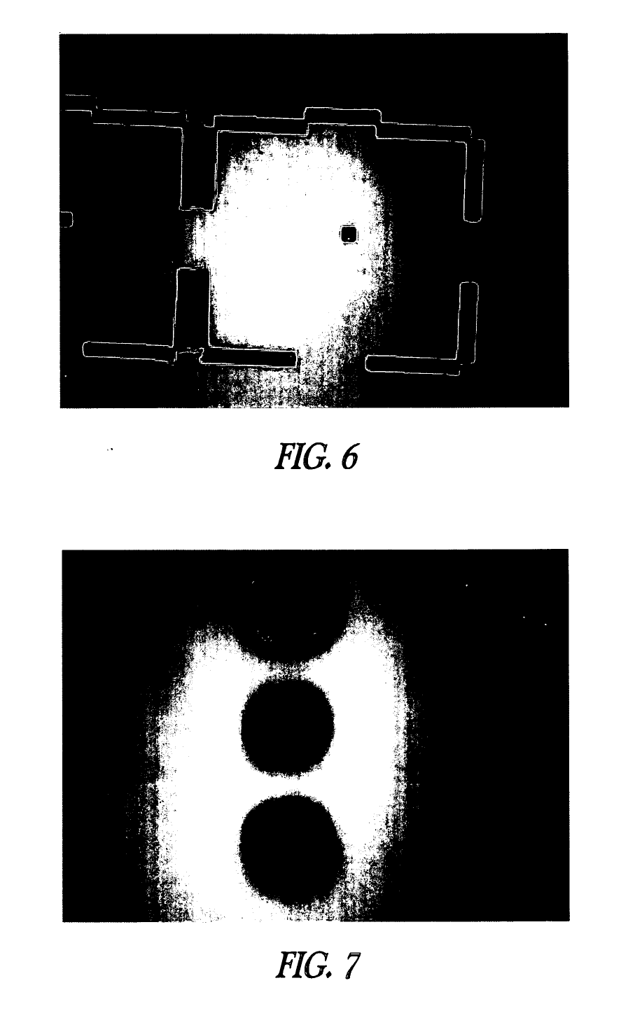

In FIG. 5, a PDMS (Sylgard 184) base was selectively cured by e-beam exposure at 30 keV. Unlike a DUV exposure approach for curing, no photoinitiator is required for this approach. In FIG. 5, a 10× picture of results for doses of 35 μC/cm² and 50 μC/cm² are shown. FIG. 6 shows a 10× picture of results for a dose of 80 μC/cm². FIG. 7 shows a 50× picture of results of forming square posts, sized 5 micrometers, 2 micrometers, and 1 micrometer.

The electron beam exposure can be used to obtain varying rigidity of a pre-cured polymeric surface, such as a PDMS surface, which can either be flat, or can have pillars or other surface topography. The below table illustrates various examples of surface type and thickness, surface treatment, whether a degas function is used before exposure to EBL, and the cure time and temperature of the starting PDMS sample.

| Surface type & | | Degas before | |
|---|---|---|---|
| thickness | Surface treatment | exposure | Cure temp & time |
| Planar, 20 μm | none | Yes | 70° C. for 3 h, RT |
| | | | overnight |
| Planar, 20 μm | O₂ plasma & | No | 70° C. overnight |
| | aquaSAVE | | |
| Pillars, 1 μm | O₂ plasma & | No | Already cured |
| | aquaSAVE | | |
| Pillars, 1 μm | AuPd sputter | No | Already cured |

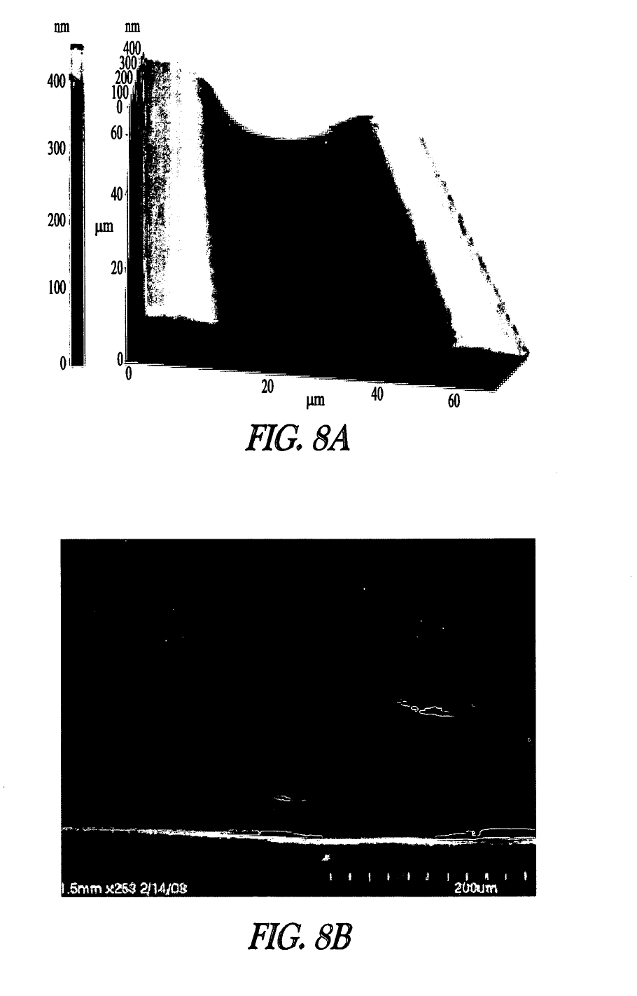

In an experiment, when cured PDMS was exposed to an electron beam without providing a conducting discharge layer (such as a AuPd sputter layer), blistering and delamination resulted, as illustrated in FIGS. 8A-B and 9A-F. Size changes can possibly be due to charging. Energy from the primary electrons can be retained by such an ungrounded sample. In this example, the area around the EBL-exposed pattern can shrink down, such as by about 400 nanometers, but the EBL-patterned lines themselves can be raised up, such as by about 5 nanometers. A conducting discharge layer, which can be grounded, can be provided before carrying out the EBL to selectively expose the PDMS or other starting material. A conducting discharge layer can include gold, gold palladium, aluminum, other metals, or combinations of metals. A conducting discharge layer can include a metal layer, a semiconductor layer, a conductive polymer layer, a semi-metal layer, or various combinations thereof. In various embodiments, the conducting discharge layer is removed after EBL modification of a cross-linkable polymer. In other embodiments, at least a portion of the conducting discharge layer is retained as part of the structure being fabricated.

FIG. 10 shows an example of a 20 micrometer thick layer of cured PDMS on a silicon substrate before electron beam exposure, and without any conducting discharge layer. A Dektak profilometer revealed blisters of up to about 2 to 8 micrometers. An atomic Force Microscopy (AFM) tip can be used to apply a constant force to a substrate. The AFM software can calculate an elastic modulus, which provides a measure of substrate thickness. In an example, AFM indicated that EBL-exposure can cause certain regions to shrink down by about 500 nanometers.

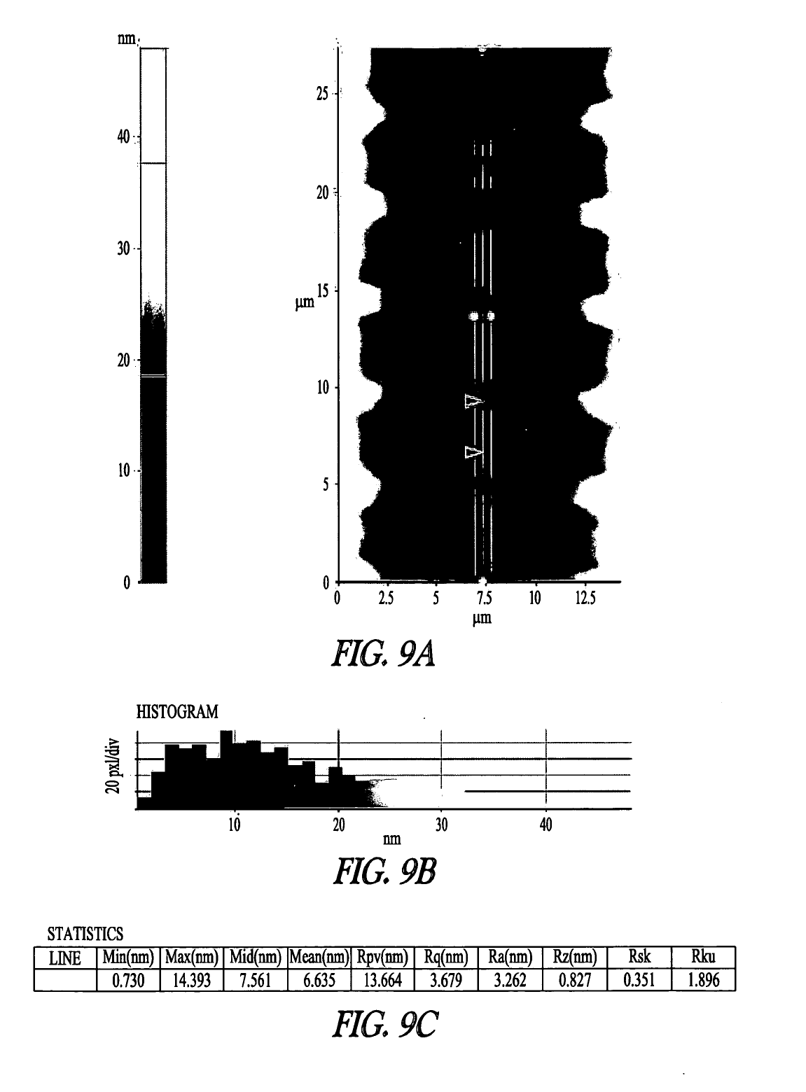

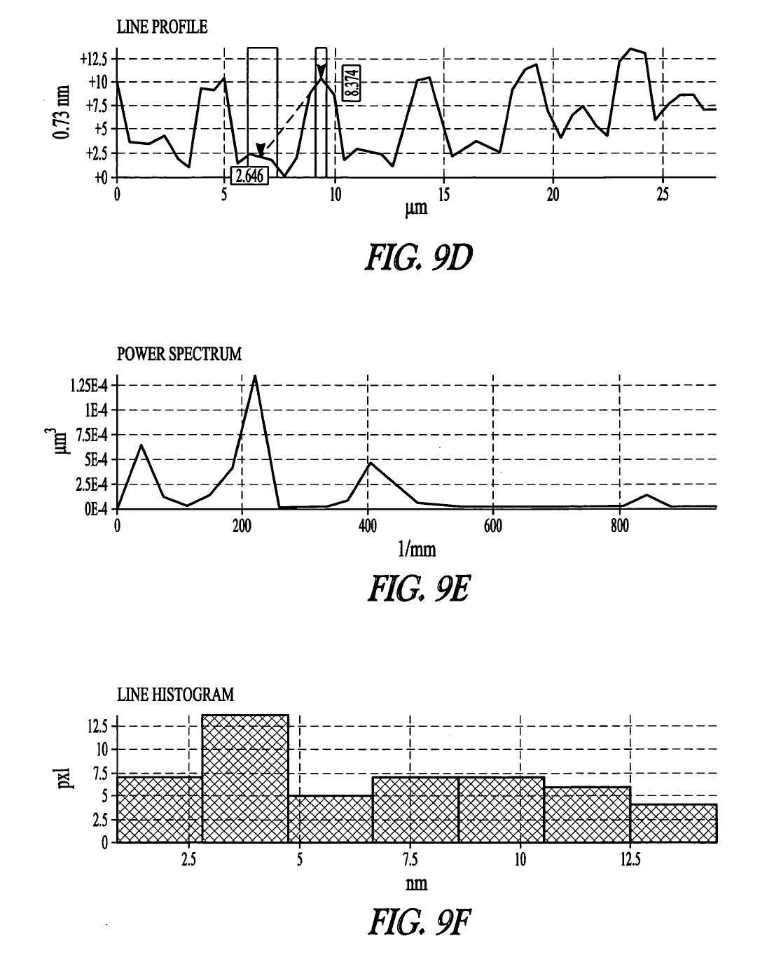

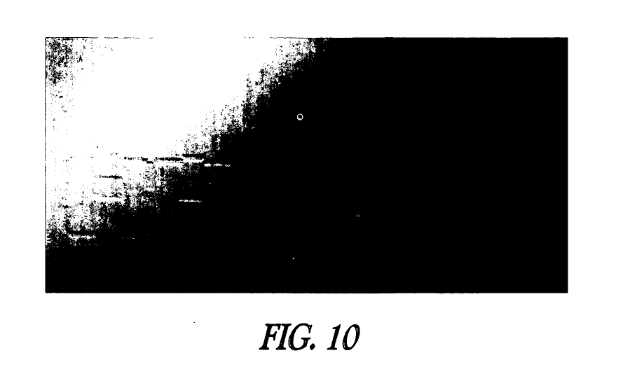

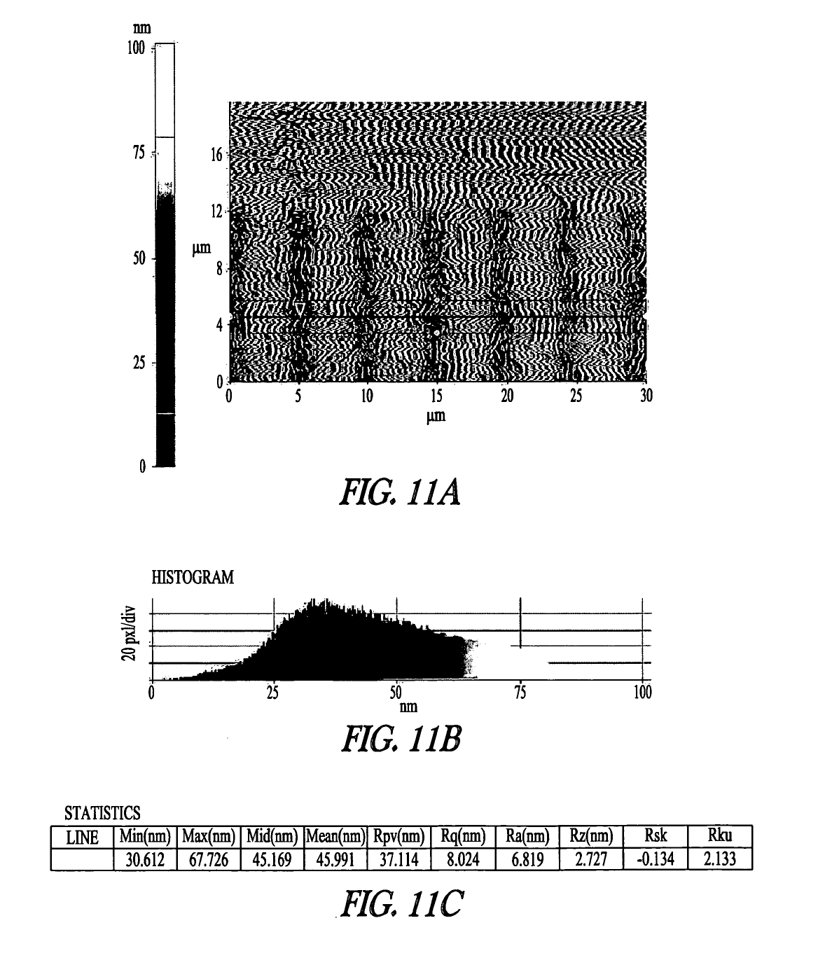

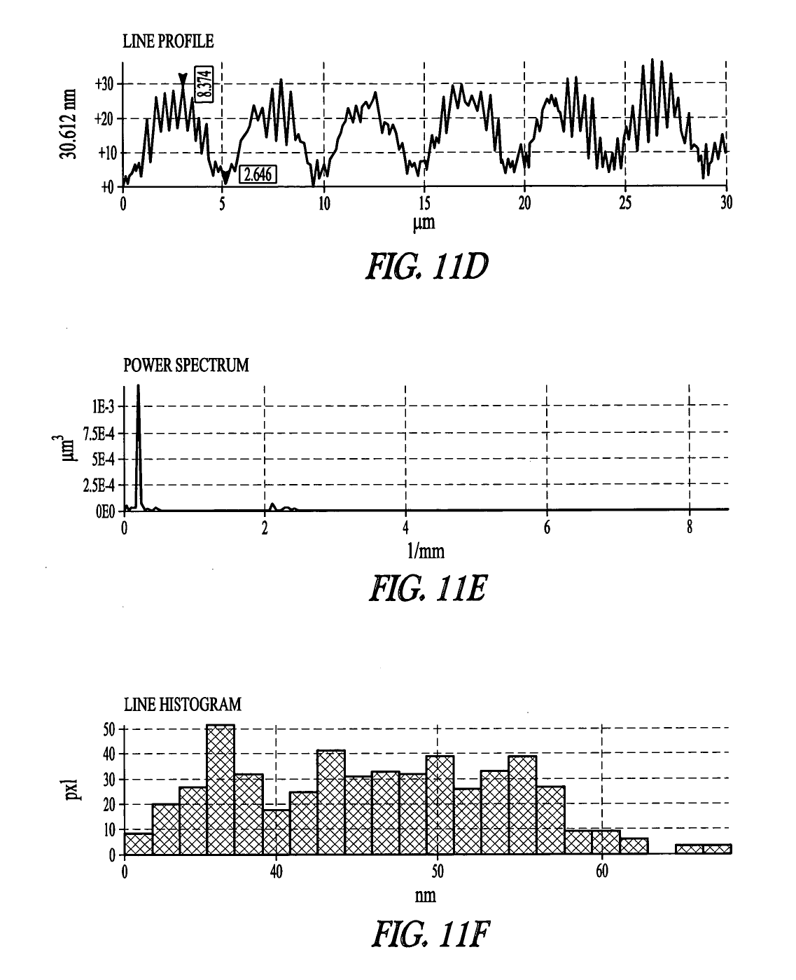

FIG. 11A-11F show an example of AFM results of cured PDMS on a silicon substrate with a discharge layer (e.g., aquaSAVE) provided, then exposed to an electron beam. The aquaSAVE is a water soluble conductive polymer available from Mitsubishi Rayon America, Inc., and can provide a spin-on conductive layer on the PDMS, which can be grounded or otherwise connected to provide an electrostatic discharge (ESD) or other discharge path during the EBL. In the above example, before carrying out the pre-EBL aquaSAVE treatment, the PDMS was first treated with an oxygen plasma. Since PDMS is hydrophobic, the oxygen plasma is applied to reduce the hydrophobicity. This reduction in hydrophobicity allows the aquaSAVE to spread more evenly on the surface. After EBL, the exposed area was indented by about 25 nanometers. The initial results (at left) may be due to charging and surface delamination.

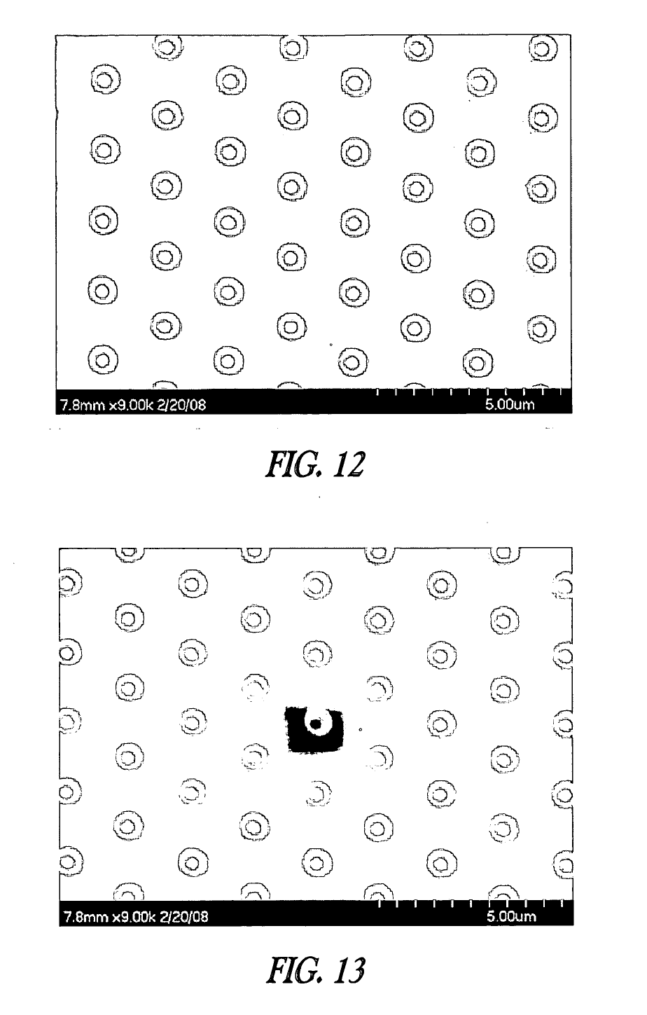

In another example, a pre-molded pillared PDMS surface was selectively exposed to EBL. FIG. 12 shows the surface with no electron beam exposure. FIG. 13 shows the pillared PDMS material after selective exposure to an electron beam dose of about 150 microCoulombs per square centimeter. FIG. 14 shows a comparison between exposed and unexposed regions of the pillared PDMS material. Increasing rigidity is evident in the exposed portion of the delaminated sample.

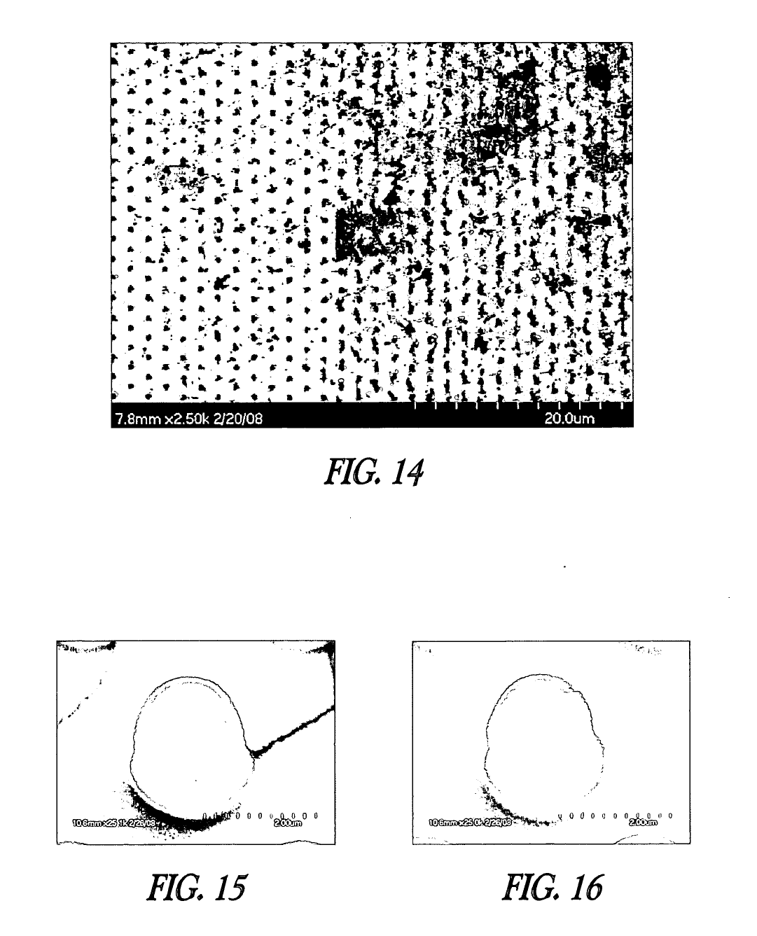

FIGS. 15 and 16 compare the dimensions of an example of exposed and unexposed pillars of PDMS material. FIG. 15 shows exposure to an E-beam dose=60 μC/cm², where the SEM tilt=28°, with a resulting effective width of 1.33 μm and height of 0.852 μm. FIG. 16 shows the unexposed structure, where the SEM tilt=20°, with a resulting effective width of 1.35 μm and height of 0.935 μm. From the examples shown in FIGS. 15 and 16, it can be observed that there is not a significant difference in dimension between exposed and unexposed pillars. This demonstrates that it is possible to obtain uniformly-sized pillars of varying rigidity. In studying the effect of rigidity in a microstructure environment (such as an ECM) for living cells, this can help ensure that the observed reaction of the cells are determined by pillar rigidity, rather than by pillar shape. In general, rigidity increases with increasing electron beam dose, such as shown in FIG. 17. Data point 1702 indicates an accepted elastic modulus of cured PDMS. In experiments, increased e-beam exposure provided data points 1705 indicating modification of the elastic modulus. However, data points 1703 at low e-beam exposure provided no good data, because the tip of the nanoindenter was not designed to be used for a stiffness that is soft corresponding to these low exposure doses.

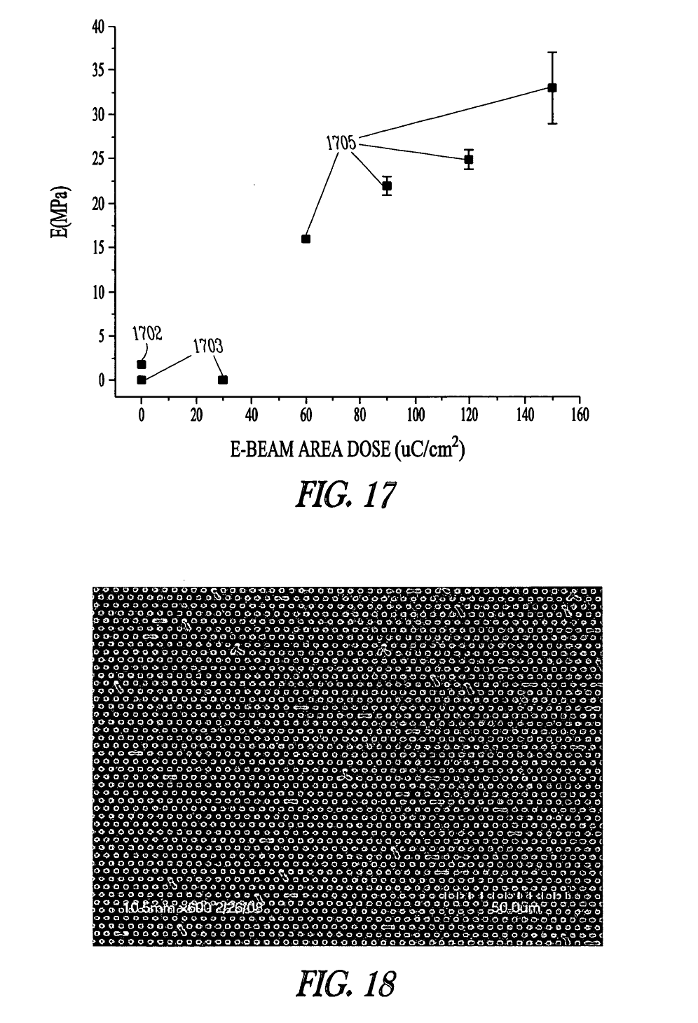

FIG. 18 shows an example of results in which a pillared PDMS substrate was sputter-coated with AuPd before electron-beam exposure. Such sputter coating can avoid a need for O₂ plasma pre-treatment of the PDMS substrate to reduce hydrophobicity before applying aquaSAVE. Use of aquaSAVE may also involve critical-point drying in another liquid, such as liquid CO₂, which can be avoided using the sputter coating approach. Moreover, because tall PDMS pillars can stick together or fall over in a liquid, such as aquaSAVE, storage in ethanol may be advisable. In certain examples, a layer of aluminum can be evaporated on top of dried pillars, exposed, and then removed, such as with NaOH or KOH.

When modifying an elastomer that has been patterned in micron scaled pillars that are flexible, critical point drying can be used to avoid problems of pillar bending and sticking together of pillars. When the surface of the elastomer having pillars is placed into a liquid, such as water, and removed, the surface tension of the liquid pulls on the pillars and can cause them to distort. For example, Aqua Save applied to an elastomer, such as PDMS, can be removed after the lithography operation in various example embodiments. Removing Aqua Save can involve dipping it in water, where the Aqua Save dissolves. When the structure is removed from the water, water, which has a high surface tension, bends the pillars and sometimes causes pillars to stick to one another. This can be avoided by performing critical point drying. Critical point drying involves taking the structure from water while it is still wet, putting it into another liquid typically alcohol, such as ethanol, and then transferring from the alcohol to carbon dioxide. The carbon dioxide, which starts out in liquefied form, is then placed under high pressure at elevated temperature. It undergoes a phase transformation through its critical point. Critical point drying allows the carbon dioxide to go through the critical point, again at elevated pressure and temperature, basically turning into a gas. There is no evaporation involved such that the carbon dioxide goes immediately from liquid to gas through the critical point without causing a surface tension problem, which avoids the collapse or the sticking of flexible pillars.

The experiments and examples described herein demonstrate, by way of example, but not by way of limitation, that an elastomer, such as a PDMS, can be cured by electron beam exposure. EBL can modulate rigidity of cured PDMS within a readily-accessible dose range. This can help in constructing custom-made substrates for different types of living cells. Such substrates can be used to test cell response to varying rigidity, among other things. In addition or alternative to EBL, UV and DUV light exposure can also be used to selectively vary the rigidity of a PDMS or other polymeric sample. However, EBL can offer a higher resolution potential than DUV, for example. The rigidity of individual pillars, recessed pit sidewalls, or other microstructures can be measured in various ways, such as by using a nanoindenter, lateral force microscopy, or other technique. Because of the ability to spatially control the electron dose on a localized basis, it is possible to create a surface with a rigidity gradient, or other arbitrarily spatially-varying rigidity. In particular, planar or topographical structures of varying rigidity are useful in creating microenvironmental or large-scale cell assays, such as for studying or use with fibroblasts, stem cells, or other living cells.

FIG. 19 shows a cell 1902 on a substrate 1901 on which a biocompatible polymeric structure is disposed, where the surface 1903 of the biocompatible polymeric structure includes pillars 1904. Surface 1903 provides a base surface from which pillars 1904 extend. Rigidity among pillars 1904 can be varied. In addition, rigidity of a single pillar or of a selected group of pillars or a selected region can be varied along a vertical dimension that extends from base surface 1903. The variation of rigidity along a vertical dimension is not limited to pillars extending vertically from a base surface, but may be applied to a localized structure extending downward from a base surface, such as in a trench.

The structure shown in FIG. 19 can be used for testing cell response. The biocompatible polymeric structure can include a PDMS surface with raised pillars. The pillars can be structured to have a diameter that is between about 1 nanometer and about 100 micrometers. The pillars can be structured to have a diameter of about 1 micrometer. The pillars can be structured to have a height that is between about 1 nanometer and about 100 micrometers. The pillars can be structured to have a height that is about 1 micrometer. The pillars can be structured to have a center-to-center spacing that is between about 20 nanometers and about 100 micrometers. Pillars with other dimensions can be constructed and used. Structural forms for biocompatible polymeric material other than pillars can be fabricated and modified according to various embodiments similar to or identical to those discussed herein.

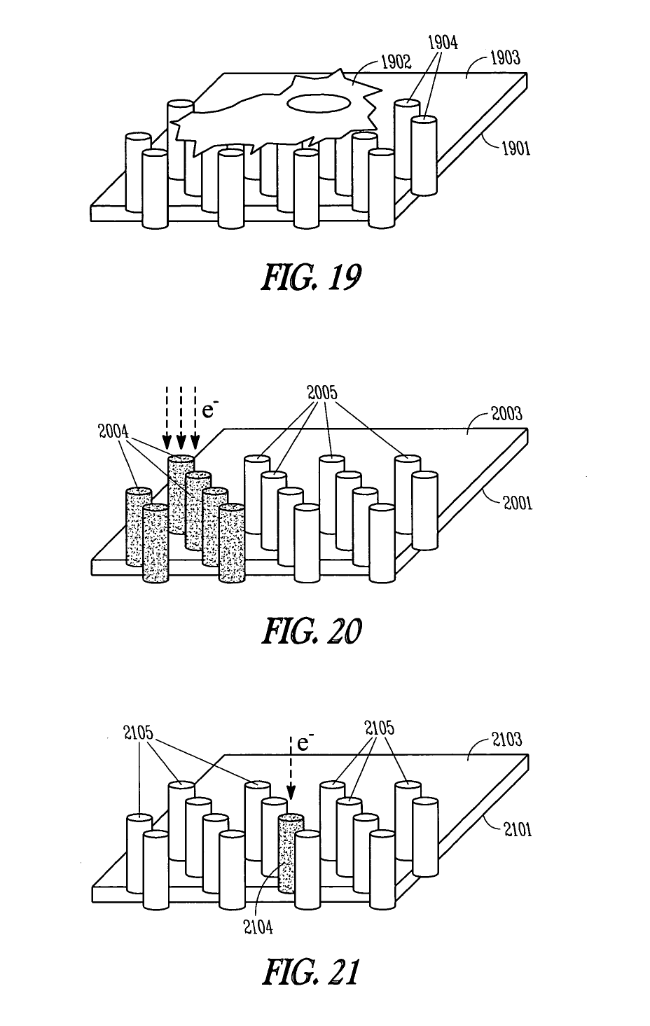

FIG. 20 shows a surface with patterned areas of gradients of pillars having varying rigidity. An electron beam modifies pillars 2004 without modifying pillars 2005 of surface 2003 on substrate 2001. The rigidity can be selected to have a rigidity gradient in a linear direction across the surface, such as a PDMS surface. The rigidity can be selected to have a rigidity gradient in a radial direction across the PDMS surface from a center location. FIG. 21 shows a surface with rigidity selected to have a rigidity gradient changing in an arbitrarily selected pattern from a selected position. An electron beam modifies single pillar 2104 without modifying pillars 2105 of surface 2103 on substrate 2101.

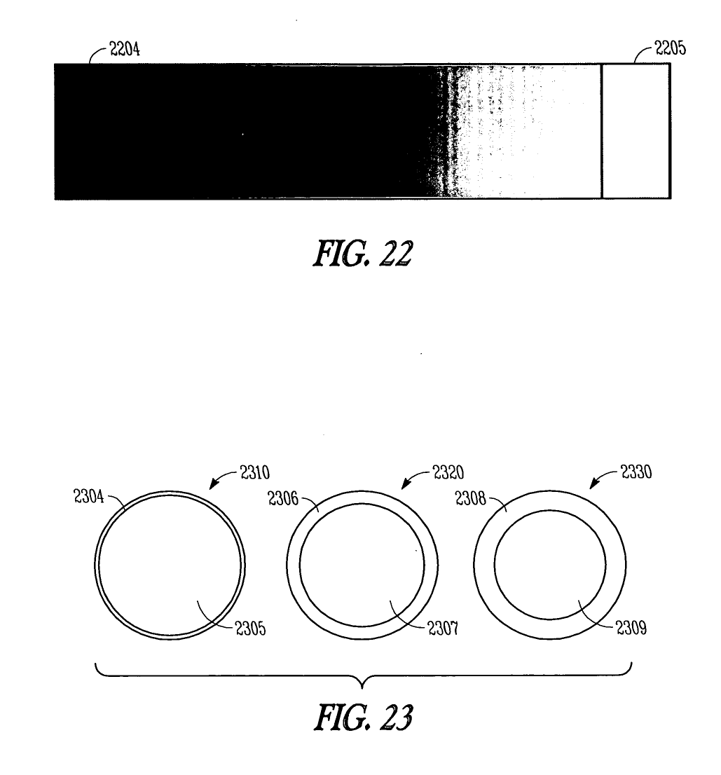

FIG. 22 shows a region of a surface in which the rigidity of the surface varies from a flexible area 2205 to a rigid area 2204. The region from flexible area 2205 to rigid area 2204 can be substantially flat. In traversing the region from the flexible area 2205 to the rigid area 2204, the rigidity can vary in a linear manner. The rigidity can vary in a non-linear manner. Though the region is shown horizontally, it may be vertically oriented. Controlling the angle of incidence of the charged particles or electromagnetic radiation, the region shown in FIG. 22 can be oriented upward or downward from a base surface.

FIG. 23 illustrates varying rigidity among pillars. Pillar 2310 has a flexible region 2305 with a small region inward from the pillar surface being rigid 2304. Pillar 2320 has a flexible region 2307 with a region inward from its pillar surface being rigid 2306 over a larger distance from its pillar surface than for pillar 2310. Pillar 2330 has a flexible region 2309 with a region inward from its pillar surface being rigid 2308 over a larger distance from its pillar surface than for pillar 2320. The rigidity along the surface of each of pillars 2310, 2320, and 2330, when the pillars are in a raised orientation from the substrate on which they are disposed, can also be modified.

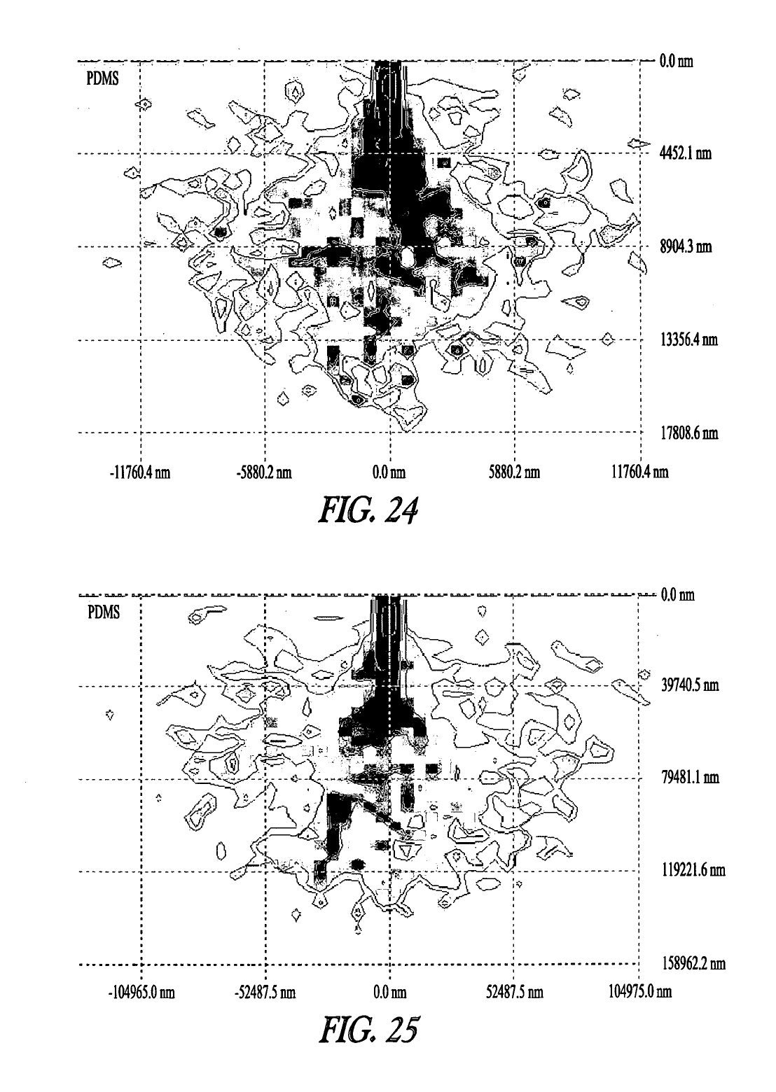

FIG. 24 shows a Monte Carlo simulation of energy distribution from a PDMS surface subjected to 30 kV generated electrons. FIG. 25 shows a Monte Carlo simulation of energy distribution from a PDMS surface subjected to 100 kV generated electrons. The depth of energy distribution in the PDMS surface is larger for the higher voltage. Comparison of FIGS. 24 and 25 demonstrates that the rigidity of an elastomer layer can be modulated by controlling the energy of the charged particles or electromagnetic radiation to which the elastomer layer is selectively subjected.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided. Although various portions of the above description have emphasized EBL treatment of PDMS, the technique can include EBL, ion beam irradiation, or photonic treatment of a suitable polymer, which can be other than PDMS, if desired.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls. In this document, the term “or” is used to refer to a nonexclusive or, such that “A or B” includes “A but not B,” “B but not A,” and “A and B,” unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A method of adjusting a mechanical property of a structure comprising:
subjecting an elastomer to charged particles or electromagnetic radiation with the elastomer disposed having a pattern on a substrate; and
controlling dosages of the charged particles or the electromagnetic radiation such that rigidity of the elastomer is selectively adjusted at localized portions of the elastomer.

2. The method of claim 1, wherein the localized portions of the elastomer extend from a base surface of the elastomer on the substrate.

3. The method of claim 1, wherein controlling dosages of the charged particles or the electromagnetic radiation includes selectively adjusting rigidity along a vertical dimension of localized portions of the elastomer that extend from a base surface of the elastomer on the substrate.

4. The method of claim 1, wherein controlling dosages of the charged particles or the electromagnetic radiation includes varying the energy of the charged particles or the electromagnetic radiation.

5. The method of claim 1, wherein controlling dosages of the charged particles or electromagnetic radiation includes selectively accelerating a controlled dose of electrons towards the elastomer.

6. The method of claim 5, wherein selectively accelerating a controlled dose of electrons towards the elastomer includes selectively accelerating a controlled dose of electrons towards a polydimethylsiloxane (PDMS) layer.

7. The method of claim 1, wherein subjecting an elastomer to charged particles or electromagnetic radiation includes subjecting the elastomer to an ion beam.

8. The method of claim 1, wherein the method includes coupling a conductive layer to the elastomer.

9. The method of claim 1, wherein controlling dosages of the charged particles or electromagnetic radiation such that rigidity of the elastomer is selectively adjusted at localized portions of the elastomer includes adjusting a rigidity of a pillar without substantially affecting a size of the pillar.

10. The method of claim 1, wherein subjecting an elastomer to charged particles or electromagnetic radiation includes subjecting an elastomer having a pillared surface toward which the charged particles or electromagnetic radiation are directed.

11. The method of claim 1, wherein the rigidity is selectively adjusted to rigidity values selected to be between about 200 Pa and about 1 GPa.

12. A method of adjusting a mechanical property of a structure comprising:
subjecting an elastomer to charged particles or electromagnetic radiation, the elastomer disposed on a substrate, the elastomer being a biocompatible material; and
controlling dosages of the charged particles or the electromagnetic radiation such that rigidity of the elastomer is selectively adjusted at localized portions of the elastomer, the rigidity corresponding to rigidity values selected to affect a characteristic of a living cell and the rigidity corresponding to a spatial dimension, associated with the rigidity values, that is also selected to affect the characteristic of the living cell.

13. The method of claim 12, wherein subjecting an elastomer to charged particles or electromagnetic radiation includes subjecting polydimethylsiloxane (PDMS) to electrons.

14. The method of claim 12, wherein the rigidity values and the spatial dimension are selected to affect cancerous cell growth.

15. The method of claim 12, wherein the rigidity values and the spatial dimension are selected to affect stem cell differentiation.

16. A structure comprising:
a substrate; and
an elastomer disposed on the substrate, the elastomer having a surface of locally varying rigidity patterned based on a specified criterion.

17. The structure of claim 16, wherein the rigidity is selected to have rigidity values between about 200 Pa and about 1 GPa.

18. The structure of claim 16, wherein the elastomer includes a biocompatible elastomer.

19. The structure of claim 18, wherein the biocompatible elastomer comprises polydimethylsiloxane (PDMS).

20. The structure of claim 16, wherein the specified criterion includes a biocompatible elastomer having locally varying rigidity corresponding to rigidity values selected to affect a characteristic of a living cell and having a spatial dimension, associated with the rigidity values, that is also selected to affect the characteristic of the living cell.

21. The structure of claim 20, wherein the rigidity values and the dimension of the localized spatial region are selected to affect cancerous cell growth.

22. The structure of claim 20, wherein the rigidity values and the dimension of the localized spatial region are selected to affect stem cell differentiation.

23. The structure of claim 16, wherein the surface includes raised pillars.

24. The structure of claim 16, wherein the rigidity is selected to have a rigidity gradient in a linear direction across the surface from a selected position on the surface.

25. The structure of claim 16, wherein the surface of locally varying rigidity includes localized portions of the elastomer that extend from a base surface of the elastomer on the substrate.

26. The structure of claim 16, wherein the surface of locally varying rigidity includes varying rigidity along a vertical dimension of localized portions of the elastomer that extend from a base surface of the elastomer on the substrate.

27. The structure of claim 16, wherein the elastomer includes one or more structures extending from a base surface of the elastomer, each of the one or more structures having a varying rigidity from an outer surface of the respective structure inward to a central region of the respective structure.
